(19) United States
(12) Patent Application Publication
(10) Pub. No.: US 2025/0342067 A1
(43) Pub. Date: Nov. 6, 2025

(54) ALLOCATING LOGICAL PARTITIONS IN A COMPUTING ENVIRONMENT WITH MULTIPLE PROCESSOR CORE TYPES

(71) Applicant: International Business Machines Corporation, Armonk, NY (US)

(72) Inventors: Jeffrey G. Chan, Brooklyn, NY (US); Seth E. Lederer, Staatsburg, NY (US); Jerry A. Moody, LaGrangeville, NY (US); Brian Fernandez, Poughkeepsie, NY (US); David Shane Hutton, Tallahassee, FL (US)

(21) Appl. No.: 18/654,052

(22) Filed: May 3, 2024

(51) Int. Cl. G06F 9/50

(52) U.S. Cl. CPC G06F 9/5077

(57) ABSTRACT

A method includes receiving a request to create a logical partition. The method further includes determining whether the logical partition can be implemented on a single drawer of a plurality of drawers. The method further includes, responsive to determining that the logical partition can be implemented on a single drawer of the plurality of drawers, allocating the logical partition to one of the drawers of the plurality of drawers based on a container size that can fit the logical partition. The method further includes, responsive to determining that the logical partition cannot be implemented on a single drawer of the plurality of drawers, allocating the logical partition to at least two drawers of the plurality of drawers using bitmasks, wherein each of the bitmasks represents a processor chip of a plurality of processor chips, and wherein one bitmask is generated per drawer of the plurality of drawers.

### BACKGROUND

The present disclosure relates to computing environments, and more specifically, to allocating logical partitions in a computing environment with multiple processor core types.

Some computing environments, like z/Architecture-based computing environments from International Business Machines, provide private, secure, and resilient hybrid multicloud computing capabilities. z/Architecture-based computing environments use a specialized instruction set architecture that offers advanced features, such as extensive memory addressing, support for vector and scalar processing, and specialized instructions for tasks like cryptographic operations.

Such computing environments provide for sharing physical system resources (e.g., processing resources, memory resources, data storage resources, and/or the like, including combinations and/or multiples thereof) among multiple logical partitions. A logical partition (LPAR) is a subset of the physical system resources, which are virtualized as a separate computer instance, referred to as a “virtual machine.” Virtual machines share the physical resources of the shared physical hardware environment and provide a virtual environment that is isolated from the underlying physical machine and/or other virtual machines.

A hypervisor, also known as a virtual machine monitor (VMM), is used to manage virtual machines. The hypervisor acts as a layer of abstraction between the physical hardware of the shared physical hardware environment and the virtualized operating systems of the virtual machines, providing for multiple virtual machines to run simultaneously on the same shared physical hardware environment. The hypervisor allocates resources, such as processing resources, memory resources, and storage resources, to each virtual machine and ensures they operate securely and efficiently. Using the allocated resources, each virtual machine can perform various tasks, such as processing, data storage, and/or the like, including combinations and/or multiples thereof. For example, a virtual machine can execute applications that run on the virtualized operating system of the virtual machine using the allocated resources of the shared physical hardware environment.

### SUMMARY

According to an embodiment, a computer-implemented method for allocating logical partitions in a computing environment with multiple processor core types is provided. The method includes receiving a request to create a logical partition for a computing environment, the computing environment comprising a plurality of drawers, each of the plurality of drawers comprising a plurality of nodes, each of the plurality of nodes comprising a plurality of processor chips, each of the plurality of processor chips having a plurality of processor cores being of one of a plurality of processor core types. The method further includes determining whether the logical partition can be implemented on a single drawer of the plurality of drawers. The method further includes, responsive to determining that the logical partition can be implemented on a single drawer of the plurality of drawers, allocating the logical partition to one of the drawers of the plurality of drawers based on a container size that can fit the logical partition. The method further includes, responsive to determining that the logical partition cannot be implemented on a single drawer of the plurality of drawers, allocating the logical partition to at least two drawers of the plurality of drawers using bitmasks, wherein each of the bitmasks represents a processor chip of the plurality of processor chips, and wherein one bitmask is generated per drawer of the plurality of drawers.

Other embodiments described herein implement features of the above-described method in computer systems and computer program products.

The above features and advantages, and other features and advantages, of the disclosure are readily apparent from the following detailed description when taken in connection with the accompanying drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of one or more embodiments described herein are apparent from the following detailed description taken in conjunction with the accompanying drawings in which:

FIG. 1 illustrates a computing environment, according to an embodiment;

FIGS. 2A and 2B together illustrate a computing environment, according to an embodiment;

FIG. 3 illustrates a flow diagram of a method for allocating logical partitions in a computing environment with multiple processor core types, according to an embodiment;

FIG. 4 illustrates a flow diagram of a method for allocating logical partitions in a computing environment based on processor core type without spanning drawers of the computing environment, according to an embodiment;

FIG. 5 illustrates a flow diagram of a method for allocating logical partitions in a computing environment based on processor core type while spanning drawers of the computing environment, according to an embodiment; and

FIGS. 6A-6D illustrate tables for allocating logical partitions in a computing environment with multiple processor core types, according to embodiments.

The detailed description explains embodiments of the disclosure, together with advantages and features, by way of example with reference to the drawings.

### DETAILED DESCRIPTION

One or more embodiments described herein provide for allocating logical partitions in a computing environment with multiple processor core types. An example of such a computing environment is a z/Architecture-based computing environment, although other types of computing environments are contemplated and within the scope of the present disclosure. More particularly, one or more embodiments provides for minimizing cross-drawer placement of logical partitions of a computing environment with multiple processor core types. One or more examples provides for placing logical partitions for consistency within and between hardware generations of computing environments.

Descriptions of various embodiments of the present disclosure are presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

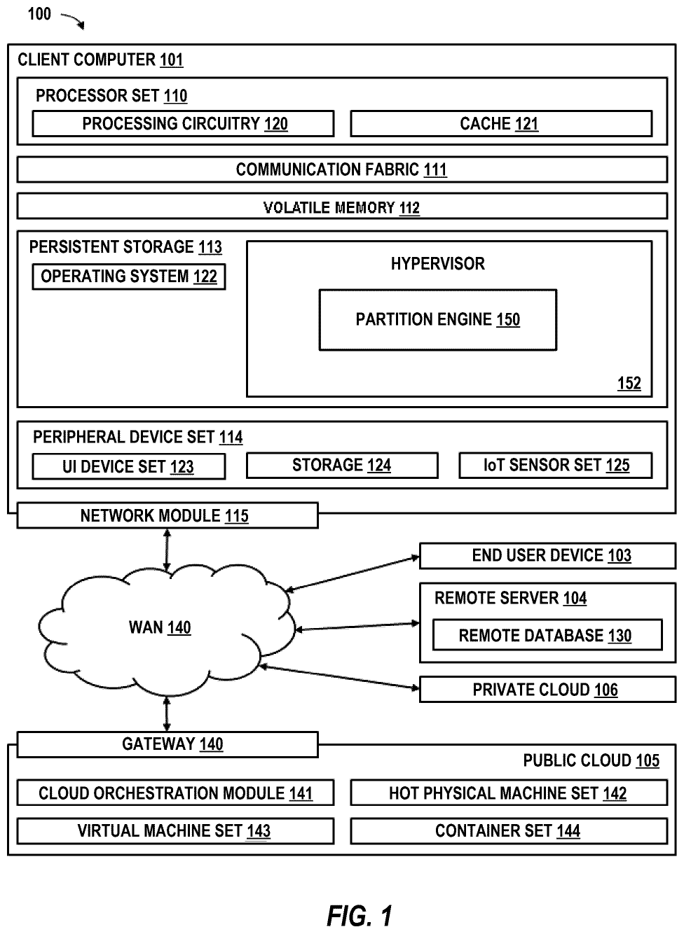

FIG. 1 illustrates a computing environment 100, according to an embodiment. Computing environment 100 contains an example of an environment for the execution of at least some of the computer code involved in performing the inventive methods, such as a partition engine 150 for allocating logical partitions in a computing environment with multiple processor core types. According to one or more embodiments, the partition engine 150 can be incorporated into and/or managed by a hypervisor 152. In addition to partition engine 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and partition engine 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in partition engine 150 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel. The code included in partition engine 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

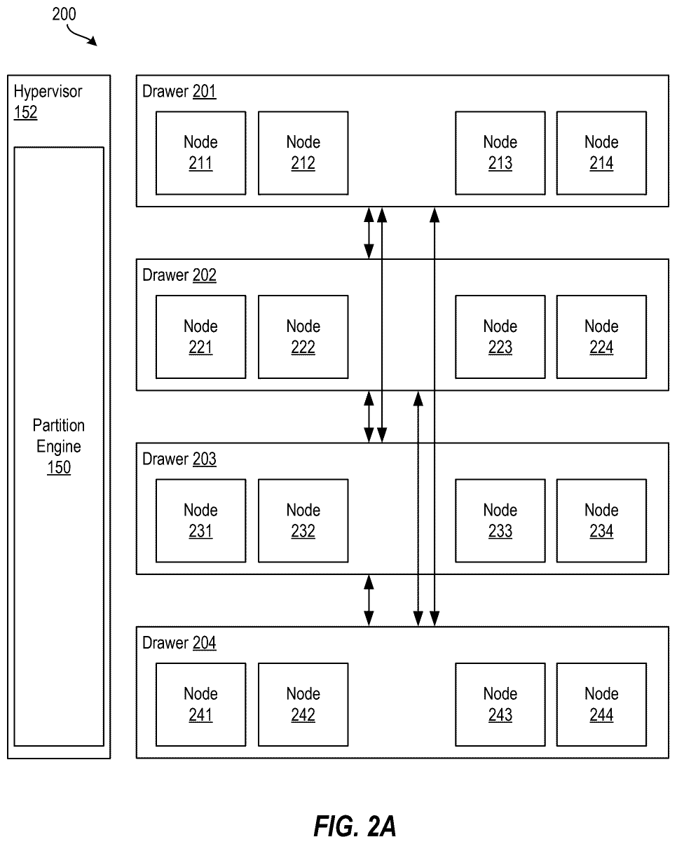

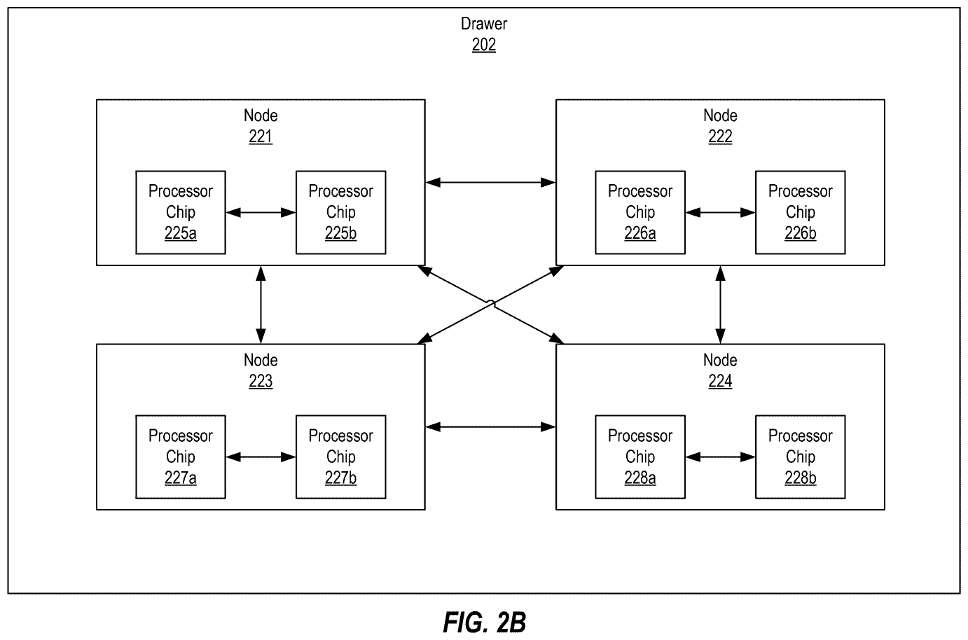

FIGS. 2A and 2B together illustrate a computing environment 200, according to an embodiment. In this example, the computing environment 200 is a multi-node computing environment. The computing environment 200 includes a plurality of interconnected drawers 201, 202, 203, 204. Each of the drawers 201-204 includes four nodes, which may also be referred to as “dual chip modules” (DCMs) “central processor clusters” (CP clusters), configured and arranged as shown. For example, the drawer 201 includes nodes 211, 212, 213, 214; the drawer 202 includes nodes 221, 222, 223, 223; the drawer 203 includes nodes 231, 232, 233, 234; the drawer 204 includes nodes 241, 242, 243, 243.

The computing environment 200 can also include the hypervisor 152, which, among other things, allocates logical partitions using the partition engine 150. That is, the partition engine 150 allocates logical partitions among one or more of the drawers 201-204 as further described herein.

With continued reference to FIG. 2A, each of the drawers 201-204 are fully interconnected as shown. That is, the drawer 201 is communicatively connected directly to the drawers 202, 203, and 204; the drawer 202 is communicatively connected directly to the drawers 201, 203, and 204; the drawer 203 is communicatively connected directly to the drawers 201, 202, and 204; and the drawer 204 is communicatively connected directly to the drawers 201, 202, and 203. In this way, the drawers 201-204, and their respective nodes, can communicate (e.g., transmit and/or receive data) amongst one another.

FIG. 2B depicts one of the drawers 201-204 (e.g., the drawer 202) of the computing environment 200 of FIG. 2A, according to an embodiment. The drawer 202 includes four nodes (e.g., nodes 221-224). Each node 221-224 includes individual processor chips. For example, the node 221 includes processor chips 225a, 225b; the node 222 includes processor chips 226a, 226b; the node 223 includes processor chips 227a, 227b; and the node 224 includes processor chips 228a, 228b. Each of the individual processor chips (e.g., processor chips 225a, 225b, 226a, 226b, 227a, 227b, 228a, 228b) can have one or multiple processing cores (e.g., 2 processing cores, 8 processing cores, 10 processing cores, etc.) and each processing core has its own private cache (e.g., L1 cache, L2 cache) (not shown). The processing cores within each individual processor chip share an L3 cache at the node level. For example, the processor chip 225a includes multiple processing cores that each has its own L1/L2 cache, and the multiple processing cores within the processor chips 225a share an L3 cache.

According to one or more embodiments, each of the processor chips (e.g., Processor chips 225a, 225b, 226a, 226b, 227a, 227b, 228a, 228b) can include various processing cores, which can be of various types. Non-limiting examples of types of processor cores include a general processor (GP) (also referred to as a “central processor” (CP), z integrated information processor (zIIP), integrated facility for Linux (IFL), and/or the like, including combinations and/or multiples thereof.

Each physical computing environment (e.g., the computing environment 100, the computing environment 200), which may be an IBM z/architecture-based system, includes a set of physical resources, such as processing resources, memory resources, data storage resources, input/output (I/O) resources, and/or the like, including combinations and/or multiples thereof. The arrangement of these physical resources is referred to as a “physical configuration.” From a hypervisor perspective, each logical partition has an associated set of requirements (e.g., requirements for processing resources, memory resources, data storage resources, I/O resources, and/or the like, including combinations and/or multiples thereof). This set of requirements is referred to as a “logical configuration.” The logical configuration can be the same or different for each logical partition.

Placement of a logical partition (e.g., mapping the logical configuration for the logical partition to the physical configuration) impacts the performance of the logical partition and the computing environment as a whole as placement affects cache access, memory access, and overall hypervisor performance (e.g. the throughput of the computing environment).

When resources for a logical partition are spread across multiple drawers (e.g., across two or more of the drawers 201-204), and it is desired to reduce cross-drawer traffic, it is desirable to reduce the span of the logical partition across drawers to the extent possible. This will cause the least impact on other running logical partitions due to cache pollution, for example.

When resources for a logical partition do not need to be spread across multiple drawers (e.g., the logical partition can be implemented on a single drawer), it is desired to maintain consistency of the placement of logical partitions by the hypervisor to maintain desired or expected system performance. Further, such consistency can aid in compliance with customer agreements for providing hosted services between different hardware configurations. This means that regardless of how many drawers are present in the physical configuration or whether workloads are on the same generation or different generations of computing environments, it is desirable to maintain consistency of the placement of logical partitions.

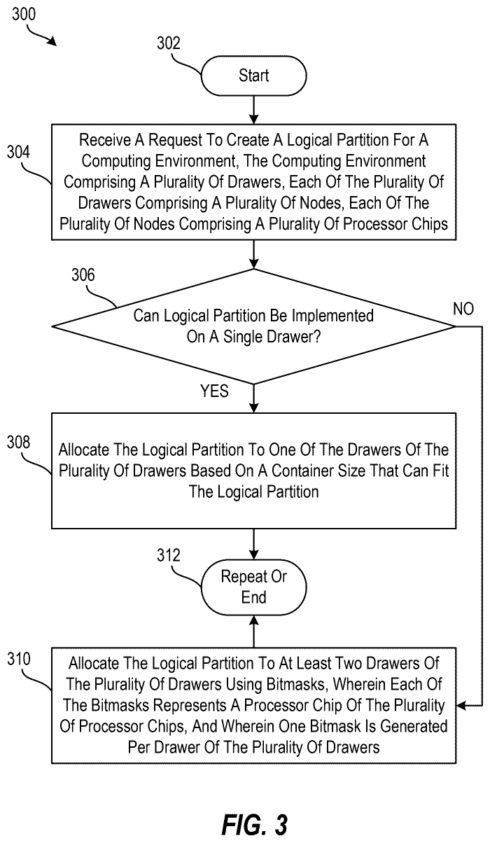

To address these and other concerns, one or more embodiments described herein provide for allocating logical partitions in a computing environment with multiple processor core types. Such embodiments provide consistency of the placement of logical partitions regardless of how many drawers are present in the physical configuration or whether workloads are on the same generation or different generations of computing environments. Embodiments for allocating logical partitions are now described in more detail with reference to FIGS. 3-6D.

FIG. 3 illustrates a flow diagram of a method 300 for allocating logical partitions in a computing environment with multiple processor core types, according to an embodiment. The method 300 can be performed by any suitable computing system, device, or environment, such as those described herein. The method 300 is now described with reference to the computing environment 100 and the computing environment 200 but is not so limited.

At block 302 the method 300 begins and proceeds to block 304, where the partition engine 150 of the computing environment 200 receives a request to create a logical partition for the computing environment 200. The request can be received, for example, from the hypervisor 152 of the computing environment 200 or from another source (e.g., a user, another computing environment, and/or the like, including combinations and/or multiples thereof). The computing environment 200 includes a plurality of drawers (e.g., the drawers 201-204). Each of the plurality of drawers includes a plurality of nodes (e.g., the nodes 211-214, the nodes 221-224, the nodes 231-234, the nodes 241-244). Each of the plurality of nodes includes a plurality of processor chips (e.g., the processor chips 225a, 225b, 226a, 226b, 227a, 227b, 228a, 228b for the drawer 202). According to one or more embodiments, the computing environment 200 includes four drawers, each of the four drawers having four nodes, and each of the four nodes having two processor chips. It should be appreciated that other numbers of drawers, nodes, and processor chips are possible in various embodiments.

At block 304, the hypervisor 152 determines whether the logical partition can be implemented on a single drawer of the plurality of drawers. In some situations, it is desirable for a logical partition to be allocated to a single drawer (e.g., one of the drawers 201-204). Allocating a logical partition to a single drawer reduces cache pollution, for example. However, it is not always possible to allocate a logical partition to a single drawer, such as if no drawer is available with a large enough capacity to implement the logical partition.

At block 306, if it is determined that the logical partition can be implemented on a single drawer (e.g., the drawer 202). If so (block 306 “Yes”), the method 300 proceeds to block 308, where the partition engine 150 allocates the logical partition to one of the drawers (e.g., the drawer 202) of the plurality of drawers (e.g., the drawers 201-204). The allocation is based, for example, on a container size that can fit the logical partition. A container is a unit to which the logical partition can be assigned. Containers can vary in size. Examples of containers, in increasing size, include a single chip (e.g., the processor chip 225a), a single node (e.g., the node 221), two nodes (e.g., the nodes 221, 222), three nodes (e.g., nodes 221-223), a single drawer (e.g., the drawer 201). It is desirable to allocate a logical partition to the smallest possible container size to improve performance and functionality of the computing environment 200, such as to reduce cache pollution.

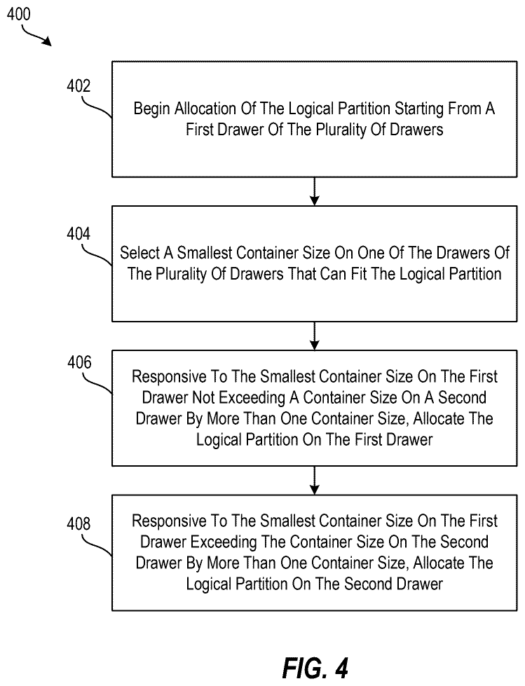

According to one or more embodiments, when a logical partition does not need to span multiple drawers, the hypervisor 152 performs a modified fill and spill algorithm. The method is not a true fill and spill since a true fill and spill algorithm would lead to performance degradation in some cases. For example, given eight chips (e.g., processor chips 225a, 225b, 226a, 226b, 227a, 227b, 228a, 228b) per drawer (e.g., the drawer 202) where only one core is available on each of the eight chips, forcing a logical partition to span the eight chips instead of spanning a single chip on another drawer (e.g., the drawer 203) would result in poor performance of the computing environment 200. By comparing the span of logical partition placement across multiple drawers and placing the logical partition in the lowest-numbered drawer (e.g., the drawer 201) unless the difference in span is more than one container level compared to other drawers (e.g., the drawers 202-204). This modified fill and spill follows a large system performance reference (LSPR) pricing model and means that this placement can be extended to any hardware configuration for the current computing environment generation or future computing environment generations (given a similar hardware topology) and the placement will be consistent between these computing environments. An example of allocating the logical partition on a single drawer is described in more detail herein with reference to at least FIG. 4.

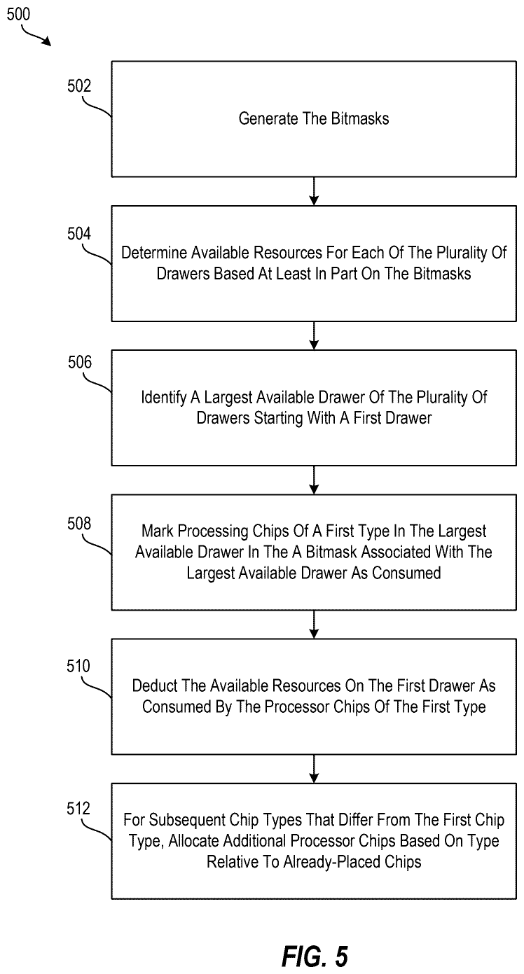

If, at block 306, it is determined that the logical partition cannot be implemented on a single drawer (block 306 “No”), the method 300 proceeds to block 310, where the partition engine 150 allocates the logical partition to at least two drawers (e.g., the drawers 201, 202) of the plurality of drawers (e.g., the drawers 201-204) using bitmasks. The bitmasks represent processor chips (e.g., processor chips 225a, 225b, 226a, 226b, 227a, 227b, 228a, 228b). According to one or more embodiments, one bitmask is generated per drawer of the plurality of drawers (e.g., the drawers 201-204). An example of allocating the logical partition on at least two drawers using bitmasks is described in more detail herein with reference to at least FIG. 5.

At block 312, subsequent to allocating the logical partition at block 308 or block 310, the method 300 can repeat, such as for subsequent logical partitions, or can terminate.

Additional processes also may be included, and it should be understood that the processes depicted in FIG. 3 represent illustrations, and that other processes may be added or existing processes may be removed, modified, or rearranged without departing from the scope of the present disclosure. It should also be understood that the processes depicted in FIG. 3 may be implemented as programmatic instructions stored on a non-transitory computer-readable storage medium that, when executed by a processor (e.g., the processor set 110, the processing circuitry 120) of a computing system (e.g., the computer 101), cause the processor to perform the processes described herein.

FIG. 4 illustrates a flow diagram of a method 400 for allocating logical partitions in a computing environment based on processor core type without spanning drawers of the computing environment, according to an embodiment. The method 400 can be performed by any suitable computing system, device, or environment, such as those described herein. The method 400 is now described with reference to the computing environment 100 and the computing environment 200 but is not so limited. According to one or more embodiments, the method 400 is an example of the functions of the partition engine 150 performed at block 308 of FIG. 3.

At block 402, the partition engine 150 begins allocating the logical partition starting from a first drawer (e.g., the drawer 201) of the plurality of drawers. According to one or more embodiments, the partition engine 150 begins the allocating with a lowest numbered drawer (e.g., the drawer 201). It should be appreciated that the drawers can be ordered in any suitable manner. As an example, the partition engine 150 begins placement on drawer j, where j is the lowest-numbered drawer.

At block 404, the partition engine 150 selects a smallest container size on one of the drawers of the plurality of drawers that can fit the logical partition. The smallest container size is selected from a drawer container size of the plurality of drawers, a node container size of the plurality of nodes, and a chip container size of the plurality of processor chips. As described herein, examples of containers, in increasing size, include a single chip (e.g., the processor chip 225a), a single node (e.g., the node 221), two nodes (e.g., the nodes 221, 222), three nodes (e.g., nodes 221-223), a single drawer (e.g., the drawer 201). AS an example, the partition engine 150 finds the smallest container size on drawer j (e.g., the drawer 201) versus drawer j+1 (e.g., the drawer 201) that can fit the logical partition.

At block 406, responsive to the smallest container size on the first drawer not exceeding a container size on a second drawer by more than one container size, the partition engine 150 allocates the logical partition on the first drawer (e.g., on the drawer 201). That is, if the container size on the drawer j does not exceed the container size on the next drawer j+1 by more than one container size (e.g., chip, node, or drawer), then the partition is allocated to the drawer j.

At block 408, responsive to the smallest container size on the first drawer exceeding the container size on the second drawer by more than one container size, the partition engine 150 allocates the logical partition on the second drawer (e.g., on the drawer 202). That is, if the container size on the drawer j exceeds the container size on the next drawer by more than one level (e.g., three nodes on drawer j versus 1 node on the drawer j+1), then the partition is allocated on the drawer j+1.

Additional processes also may be included, and it should be understood that the processes depicted in FIG. 4 represent illustrations, and that other processes may be added or existing processes may be removed, modified, or rearranged without departing from the scope of the present disclosure. It should also be understood that the processes depicted in FIG. 4 may be implemented as programmatic instructions stored on a non-transitory computer-readable storage medium that, when executed by a processor (e.g., the processor set 110, the processing circuitry 120) of a computing system (e.g., the computer 101), cause the processor to perform the processes described herein.

FIG. 5 illustrates a flow diagram of a method 500 for allocating logical partitions in a computing environment based on processor core type while spanning drawers of the computing environment, according to an embodiment. The method 500 can be performed by any suitable computing system, device, or environment, such as those described herein. The method 500 is now described with reference to the computing environment 100 and the computing environment 200 but is not so limited. According to one or more embodiments, the method 500 is an example of the functions of the partition engine 150 performed at block 310 of FIG. 3.

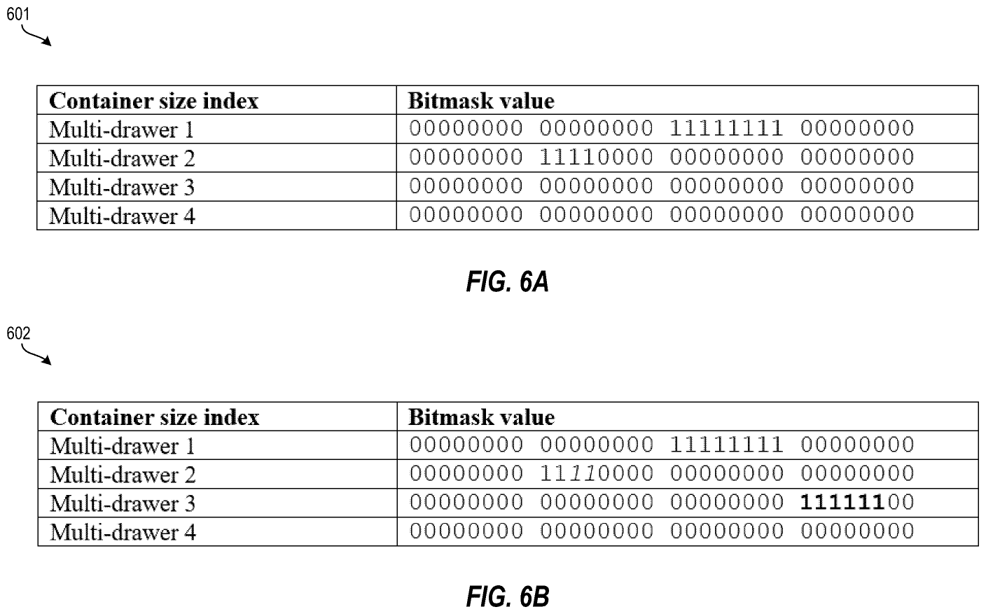

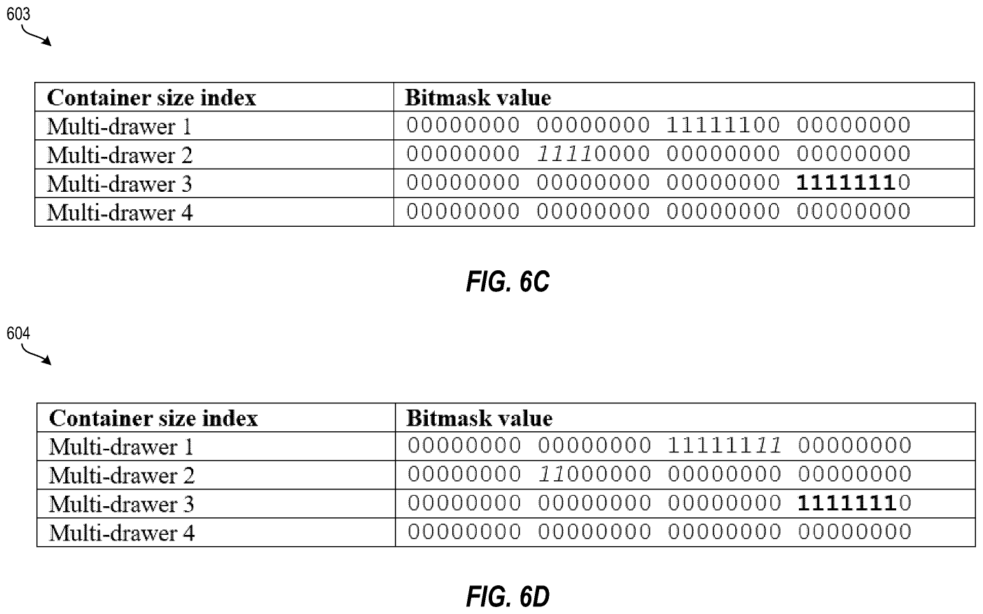

At block 502, the partition engine 150 generates the bitmasks. As described herein, the bitmasks represent processor chips (e.g., processor chips 225a, 225b, 226a, 226b, 227a, 227b, 228a, 228b). Examples of bitmasks are shown in more detail in FIGS. 6A-6D and are described further herein.

At block 504, the partition engine 150 determines available resources for each of the plurality of drawers based at least in part on the bitmasks. For example, bits of the bitmasks with a value of “0” are indicative of chips (e.g., processor chips 225a, 225b, 226a, 226b, 227a, 227b, 228a, 228b) that do not have a logical partition allocated thereto, while bits of the bitmasks with a value of “1” are indicative of chips that do have a logical partition allocated thereto.

For a first chip type (e.g., a general processor) that is allocated to a drawer, the blocks 506, 508, and 510 are performed. At block 506, the partition engine 150 identifies a largest available drawer of the plurality of drawers starting with a first drawer. The largest available drawer is the drawer with the largest amount of available chips that do not have logical partitions allocated thereto. According to one or more embodiments, identifying the largest available drawer is based on the chip type. At block 508, the partition engine 150 marks processor chips in the largest available drawer in the bitmask associated with the largest available drawer as consumed. That is, the partition engine 150 updates the bitmasks to indicate which chips have logical partitions allocated thereto. At block 510, the partition engine 150 deducts the available resources on the first drawer as consumed.

For subsequent chip types (e.g., zIIPs, IFLs) (after the first chip type that is allocated to a drawer), at block 512, additional processor chips are allocated based on type relative to the already-placed chips. Similar workload processor core types to the first chip type can be allocated together to fill remaining unused chips on any partially consumed drawer as the first chip type. For example, in FIG. 6D (discussed in more detail below), it is shown that the general processors (not italicized or bolded), are placed on the drawer. Then the zIIPs (italicized), are placed to fill the drawer 203 and then spill to the next largest drawer (e.g., the drawer 202). The zIIPs are also allocated to the drawer 202 because the zIIPs are considered to have a similar workload to the general processors, so sharing cache is acceptable. For different workload processor core types than the first chip type, those chips are allocated to a different, largest available drawer. For example, in FIG. 6D, for the IFLs (bolded), they are considered to have a much different workload compared to general processors and zIIPs, so the IFLs are placed on a separate drawer (e.g., drawer 204) from both the general processors and the zIIPs.

According to one or more embodiments, the blocks 506, 508, 510 can be repeated, such as until all resources of a particular type of chip (e.g., a CP chip, a zIIP chip, an IFL, and/or the like, including combinations and/or multiples thereof) have been satisfied but will continue with a next bitmask, marking the appropriate drawer at block 508.

According to one or more embodiments, if the next type of chip has a similar type of workload, the method 500 returns to block 504 and repats for the next chip type but continues with the last bitmask used. Otherwise, the method 500 can restart or terminate. This repetition is done to prevent cache pollution of multiple workloads, for example.

Once the resources for the logical partition have been identified, the partition engine 150 places as much entitlement on the drawer as designated by the first bitmask, followed by the second bitmask, and so on.

Additional processes also may be included, and it should be understood that the processes depicted in FIG. 5 represent illustrations, and that other processes may be added or existing processes may be removed, modified, or rearranged without departing from the scope of the present disclosure. It should also be understood that the processes depicted in FIG. 5 may be implemented as programmatic instructions stored on a non-transitory computer-readable storage medium that, when executed by a processor (e.g., the processor set 110, the processing circuitry 120) of a computing system (e.g., the computer 101), cause the processor to perform the processes described herein.

FIGS. 6A, 6B, 6C, and 6D illustrate tables 601, 602, 603, and 604, respectively, for allocating logical partitions in a computing environment with multiple processor core types, according to embodiments.

With reference to FIG. 6A, a single processor core type example is shown. Suppose a partition A needs 1.5 drawers worth of general processors (e.g., CP chip). The largest container (e.g., drawer 203) is fully consumed before consuming a portion of the next largest drawer (e.g., drawer 202). The table 601 shows bitmasks for each drawer (e.g., multi-drawers 1-4, which correspond to the drawers 201-204) in this scenario. Each bit in the bitmask represent one chip, and in this example, there are eight chips per drawer. The container sizes are evaluated from top to bottom.

With reference to FIG. 6B, a multiple processor core type example is shown. Suppose partition A needs 1.25 drawers worth of CP chips, 0.25 drawers worth of zIIP chips, and 0.75 drawers worth of IFL chips. The largest container (e.g., drawer 203) is fully consumed before consuming a portion of the next largest drawer (e.g., the drawer 202). Then, the zIIP chips continue to consume additional resources in the next largest drawer (e.g., the drawer 202). Lastly, the IFL chips consume resources in a separate drawer from the zIIP chips (e.g., the drawer 203) to prevent cache pollution. This is shown in the table 602, which includes bitmasks for each drawer (e.g., multi-drawers 1-4, which correspond to the drawers 201-204) in this scenario. Each bit in the bitmask represent one chip, and in this example, there are eight chips per drawer. The container sizes are evaluated from top to bottom. In this example, “1” values that are in italics represent the zIIP chips, “1” values that are in bold represent the IFL chips, and “1” values that are neither in italics nor bold represent general processors (e.g., CP chips).

With reference to FIG. 6C, a processing example is shown that does not apply the methods 300, 400, and/or 500. Suppose partition A needs 0.75 drawers worth of CP chips, 0.5 drawers worth of zIIP chips, and 0.85 drawers worth of IFL chips. The largest container (e.g., drawer 203) is partially consumed for all the CP chips. The next largest drawer (e.g., the drawer 202) is partially consumed for the zIIP chips, followed by the next largest drawer (e.g., the drawer 204), which is partially consumed for the IFL chips. Each bit in the bitmask represent one chip, and in this example, there are eight chips per drawer. The container sizes are evaluated from top to bottom. In this example, “1” values that are in italics represent the zIIP chips, “1” values that are in bold represent the IFL chips, and “1” values that are neither in italics nor bold represent general processors (e.g., CP chips).

With reference to FIG. 6D, a processing example is shown that does apply the methods 300, 400, and/or 500. Suppose partition A needs 0.75 drawers worth of CP chips, 0.5 drawers worth of zIIP chips, and 0.85 drawers worth of IFL chips. The largest container (e.g., drawer 203) is partially consumed for all the CP chips and is partially consumed for some of the zIIP chips. The next largest drawer (e.g., the drawer 202) is partially consumed for the remaining zIIP chips. The next largest drawer (e.g., the drawer 204) is then partially consumed for the IFL chips. This keeps similar workload processors (e.g., the CP chips and the zIIP chips) together, which minimizes cross-drawer traffic, while also minimizing cache pollution by placing the IFL chips on a separate drawer (e.g., the drawer 204). Each bit in the bitmask represent one chip, and in this example, there are eight chips per drawer. The container sizes are evaluated from top to bottom. In this example, “1” values that are in italics represent the zIIP chips, “1” values that are in bold represent the IFL chips, and “1” values that are neither in italics nor bold represent general processors (e.g., CP chips).

Although one or more embodiments are described herein as applying to computing environments that are based on IBM's z/architecture, it should be appreciated that the embodiments described herein are not so limited to and may be applied to computing environments of other architectures also. For example, a computing environment may include a CPU complex (CCX) with eight cores connected to an L3 cache. In this example, the chips may have multiple of these CCXs and therefore, the placement of logical partitions across these CCXs affect cache locality and affect system performance. One or more embodiments described herein can be applied to such an architecture by treating each of these CCXs as a chip. Therefore, two CCXs could be considered a node (e.g., the node 211) as described herein, and eight CCXs could be considered a drawer (e.g., the drawer 202). Then, since the different processor core types are only logically defined (e.g., they are the same physically), it is possible for a hypervisor to treat any of the cores as logically different, even if they are physically the same.

While the foregoing is directed to embodiments of the present disclosure, other and further embodiments of the present disclosure may be devised without departing from the basic scope thereof, and the scope thereof is determined by the claims that follow.

What is claimed is:

1. A computer-implemented method comprising:
receiving a request to create a logical partition for a computing environment, the computing environment comprising a plurality of drawers, each of the plurality of drawers comprising a plurality of nodes, each of the plurality of nodes comprising a plurality of processor chips, each of the plurality of processor chips having a plurality of processor cores being of one of a plurality of processor core types;
determining whether the logical partition can be implemented on a single drawer of the plurality of drawers;
responsive to determining that the logical partition can be implemented on a single drawer of the plurality of drawers, allocating the logical partition to one of the drawers of the plurality of drawers based on a container size that can fit the logical partition; and
responsive to determining that the logical partition cannot be implemented on a single drawer of the plurality of drawers, allocating the logical partition to at least two drawers of the plurality of drawers using bitmasks, wherein each of the bitmasks represents a processor chip of the plurality of processor chips, and wherein one bitmask is generated per drawer of the plurality of drawers.

2. The computer-implemented method of claim 1, wherein allocating the logical partition to one of the drawers of the plurality of drawers comprises:
beginning allocation of the logical partition starting from a first drawer of the plurality of drawers;
selecting a smallest container size on one of the drawers of the plurality of drawers that can fit the logical partition, the smallest container size being selected from a drawer container size of the plurality of drawers, a node container size of the plurality of nodes, and a chip container size of the plurality of processor chips;
responsive to the smallest container size on the first drawer not exceeding a container size on a second drawer by more than one container size, allocating the logical partition on the first drawer; and
responsive to the smallest container size on the first drawer exceeding the container size on the second drawer by more than one container size, allocating the logical partition on the second drawer.

3. The computer-implemented method of claim 1, wherein allocating the logical partition to the at least two drawers of the plurality of drawers using the bitmasks comprises:
generating the bitmasks;
determining available resources for each of the plurality of drawers based at least in part on the bitmasks;
identifying a largest available drawer of the plurality of drawers starting with a first drawer;
marking processor chips of a first type in the largest available drawer in a bitmask associated with the largest available drawer as consumed;
deducting the available resources on the first drawer as consumed; and
allocating additional processor chips of a type different than the first type based on type relative to the processor chips of the first type.

4. The computer-implemented method of claim 3, wherein allocating the logical partition to the at least two drawers of the plurality of drawers using the bitmasks further comprises repeating the determining, identifying, marking, and deducting for subsequent logical partitions.

5. The computer-implemented method of claim 1, wherein the plurality of drawers is four drawers, wherein the plurality of nodes is four nodes, and wherein the plurality of processor chips is two processor chips.

6. The computer-implemented method of claim 1, wherein allocating the logical partition to one of the drawers of the plurality of drawers is further responsive to the partition only certain types of processors.

7. The computer-implemented method of claim 6, wherein the certain types of processors comprise a general-purpose processor and an integrated information processor.

8. A system comprising:
a plurality of drawers, each of the plurality of drawers comprising a plurality of nodes, each of the plurality of nodes comprising a plurality of processor chips, each of the plurality of processor chips having a plurality of processor cores being of one of a plurality of processor core types;
a memory comprising computer readable instructions; and
a processing device for executing the computer readable instructions, the computer readable instructions controlling the processing device to perform operations comprising:
receiving a request to create a logical partition for the system;
determining whether the logical partition can be implemented on a single drawer of the plurality of drawers;
responsive to determining that the logical partition can be implemented on a single drawer of the plurality of drawers, allocating the logical partition to one of the drawers of the plurality of drawers based on a container size that can fit the logical partition; and
responsive to determining that the logical partition cannot be implemented on a single drawer of the plurality of drawers, allocating the logical partition to at least two drawers of the plurality of drawers using bitmasks, wherein each of the bitmasks represents a processor chip of the plurality of processor chips, and wherein one bitmask is generated per drawer of the plurality of drawers.

9. The system of claim 8, wherein allocating the logical partition to one of the drawers of the plurality of drawers comprises:
beginning allocation of the logical partition starting from a first drawer of the plurality of drawers;
selecting a smallest container size on one of the drawers of the plurality of drawers that can fit the logical partition, the smallest container size being selected from a drawer container size of the plurality of drawers, a node container size of the plurality of nodes, and a chip container size of the plurality of processor chips;
responsive to the smallest container size on the first drawer not exceeding a container size on a second drawer by more than one container size, allocating the logical partition on the first drawer; and
responsive to the smallest container size on the first drawer exceeding the container size on the second drawer by more than one container size, allocating the logical partition on the second drawer.

10. The system of claim 8, wherein allocating the logical partition to the at least two drawers of the plurality of drawers using the bitmasks comprises:
generating the bitmasks;
determining available resources for each of the plurality of drawers based at least in part on the bitmasks;
identifying a largest available drawer of the plurality of drawers starting with a first drawer;
marking processor chips of a first type in the largest available drawer in a bitmask associated with the largest available drawer as consumed;
deducting the available resources on the first drawer as consumed; and
allocating additional processor chips of a type different than the first type based on type relative to the processor chips of the first type.

11. The system of claim 10, wherein allocating the logical partition to the at least two drawers of the plurality of drawers using the bitmasks further comprises repeating the determining, identifying, marking, and deducting for subsequent logical partitions.

12. The system of claim 8, wherein the plurality of drawers is four drawers, wherein the plurality of nodes is four nodes, and wherein the plurality of processor chips is two processor chips.

13. The system of claim 8, wherein allocating the logical partition to one of the drawers of the plurality of drawers is further responsive to the partition only certain types of processors.

14. The system of claim 13, wherein the certain types of processors comprise a general-purpose processor and an integrated information processor.

15. A computer program product comprising:
a set of one or more computer-readable storage media;
program instructions, collectively stored in the set of one or more storage media, for causing a processor set to perform the following computer operations:
receiving a request to create a logical partition for a computing environment, the computing environment comprising a plurality of drawers, each of the plurality of drawers comprising a plurality of nodes, each of the plurality of nodes comprising a plurality of processor chips, each of the plurality of processor chips having a plurality of processor cores being of one of a plurality of processor core types;
determining whether the logical partition can be implemented on a single drawer of the plurality of drawers;
responsive to determining that the logical partition can be implemented on a single drawer of the plurality of drawers, allocating the logical partition to one of the drawers of the plurality of drawers based on a container size that can fit the logical partition; and
responsive to determining that the logical partition cannot be implemented on a single drawer of the plurality of drawers, allocating the logical partition to at least two drawers of the plurality of drawers using bitmasks, wherein each of the bitmasks represents a processor chip of the plurality of processor chips, and wherein one bitmask is generated per drawer of the plurality of drawers.

16. The computer program product of claim 15, wherein allocating the logical partition to one of the drawers of the plurality of drawers comprises:
beginning allocation of the logical partition starting from a first drawer of the plurality of drawers;
selecting a smallest container size on one of the drawers of the plurality of drawers that can fit the logical partition, the smallest container size being selected from a drawer container size of the plurality of drawers, a node container size of the plurality of nodes, and a chip container size of the plurality of processor chips;
responsive to the smallest container size on the first drawer not exceeding a container size on a second drawer by more than one container size, allocating the logical partition on the first drawer; and
responsive to the smallest container size on the first drawer exceeding the container size on the second drawer by more than one container size, allocating the logical partition on the second drawer.

17. The computer program product of claim 15, wherein allocating the logical partition to the at least two drawers of the plurality of drawers using the bitmasks comprises:
generating the bitmasks;
determining available resources for each of the plurality of drawers based at least in part on the bitmasks;
identifying a largest available drawer of the plurality of drawers starting with a first drawer;
marking processor chips of a first type in the largest available drawer in a bitmask associated with the largest available drawer as consumed;
deducting the available resources on the first drawer as consumed; and
allocating additional processor chips of a type different than the first type based on type relative to the processor chips of the first type.

18. The computer program product of claim 17, wherein allocating the logical partition to the at least two drawers of the plurality of drawers using the bitmasks further comprises repeating the determining, identifying, marking, and deducting for subsequent logical partitions.

19. The computer program product of claim 15, wherein the plurality of drawers is four drawers, wherein the plurality of nodes is four nodes, and wherein the plurality of processor chips is two processor chips.

20. The computer program product of claim 15, wherein allocating the logical partition to one of the drawers of the plurality of drawers is further responsive to the partition only certain types of processors.
